(19) United States
(12) Patent Application Publication
(10) Pub. No.: US 2024/0078373 A1
(43) Pub. Date: Mar. 7, 2024

(54) DYNAMICALLY COMPOSING AND MANAGING LONG FORM NOTES FROM SHORT FORM NOTE FRAGMENTS

(71) Applicant: Microsoft Technology Licensing, LLC, Redmond, WA (US)

(72) Inventor: David Conger, Issaquah, WA (US)

(73) Assignee: Microsoft Technology Licensing, LLC, Redmond, WA (US)

(21) Appl. No.: 17/929,297

(22) Filed: Sep. 1, 2022

(51) Int. Cl. G06F 40/166; G06F 40/123

(52) U.S. Cl. CPC G06F 40/166; G06F 40/123

(57) ABSTRACT

Aspects of the present disclosure relate to creating a long note from one or more short notes made in a source document. A long note is a separate document created by the system to capture each of the one or more short notes and related source content from the source document and compiles them in one place for independent review and modification. The long note captures the connection between the short note and the source document with source content such as the related text, images, or other source content within the source document to which the short note is directed. The long note may be created independently of a user request, such that the entry of a short note into the source document initiates the creation of the long note.

### BACKGROUND

The interconnectedness of the modern world has enabled multiple users to collaborate creatively on the same document in a virtual environment. Such collaboration enables multiple users to view, modify, and save their contributions to a document, including the addition of notes to the document that other users are then able to review and utilize during the collaborative process. However, while sometimes desired, the process of sharing notes outside of the document can be challenging and time consuming. Such sharing of notes outside of the document involves transferring each note into a separate note document and then distributing that separate note document. Unfortunately, the creation and population of the separate note document takes time and typically does not include enough information from the original document to be truly helpful. Indeed, such sharing of the notes separate from the document itself may cause important relational data to be missed. Moreover, given that many notes are quite short, they typically only make sense when viewed in conjunction with the document itself.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to creating a long note from one or more short notes made in a source document. A long note is a separate document created by the system to capture each of the one or more short notes and related source content from the source document and compiles them in one place for independent review and modification. The long note captures the connection between the short note and the source document with source content such as the related text, images, or other information within the source document to which the short note is directed. As described herein, such functionality involves creating an anchor point for a short note based on its position in the source document. The anchor point is utilized to connect and arrange the one or more short notes within the long note. The long note may be created independently of a user request, such that the entry of a short note into the source document initiates the creation of the long note. In some embodiments, a single long note may be created for a source document and each user may collaboratively utilize and store their created short notes in the single long note. In other embodiments, each user of a source document may have a long note created specifically for their own short notes. In this case, if three users were working on a source document then three long notes might exist, one for each user.

In instances, modification of the content of the short note or the long note is dynamically reflected in the same source content in the source document, without requiring manual source document editing by the user. Once the long note has been created, it may be utilized independently of the source document to store each short note and associated source content as a single source of truth. In some embodiments, when a long note exists, and the source document is re-accessed, short notes within the source document may be dynamically updated from the long note. Dynamic updates to the long note may occur even if the long note is not open concurrently with the source document. Similarly, dynamic updates to the source document may occur when modifications to a short note are made in the long note but not in the source document. Thus, the long note, according to aspects described herein, may improve productivity and the potential for collaboration in the workplace while reducing user workload.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 illustrates an exemplary environment for dynamically composing and managing a long note from short notes, according to aspects described herein.

FIG. 2A illustrates an exemplary source document with short notes, according to aspects described herein.

FIG. 2B illustrates a long note created for the exemplary source document of FIG. 2A, according to aspects described herein.

FIG. 3 is a diagram illustrating a system for dynamically composing and managing a long note from short notes, according to aspects described herein.

FIG. 4 is a block diagram illustrating a method for creating, managing, and dynamically updating a long note and a related source document, according to aspects described herein.

FIG. 5 is a block diagram illustrating a method for dynamically managing a long note and dynamically updating a source document from the long note, according to aspects described herein.

FIG. 6 is a block diagram illustrating example physical components of a computing device with which aspects of the disclosure may be practiced.

FIG. 7 is a simplified block diagrams of a mobile computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations, specific embodiments or examples. Aspects of the descriptions, drawings, etc. may be combined, while other aspects may be utilized, and structural changes may be made without departing from the present disclosure. Embodiments may be practiced as methods, systems or devices. Accordingly, embodiments may take the form of a hardware implementation, a software implementation, or an implementation combining software and hardware aspects. The following detailed description is therefore not to be taken in a limiting sense, and the scope of the present disclosure is defined by the appended claims and their equivalents.

In examples, users within a collaborative environment may utilize the review function within a source document to share short notes and propose edits to the source content of the source document. A short note may include brief content (e.g., a text box, image, video, etc.) directed toward or about source content in a source document. The short note may tag or be placed near the source content. For example, a short note may be a text box proposing edits to a portion of source content in a PowerPoint slide. The short note may be placed at or near the portion of the source content of the slide. Source content is the related text, images, videos, audio files, and/or other information within the source document to which the short note is directed. With reference to a small group or work setting where the users are working on a relatively simple source document, the process of source document creation, review, and short note taking may not be overly complex. However, issues arise when the source document becomes more complicated, the number of short notes increases throughout the source document, and the users working on the source document expand such that multiple users are collaborating on the source document as creators and reviewers interchangeably. In such instances, it may become difficult to manage short notes within the source document after multiple iterations of review and editing occur. Further, important source content associated with short notes within the source document may be lost as edits are made to the source document and/or the short notes. In such instances, multiple users end up with multiple documents that each have different short notes and edits without a single source document that functions as a single source of truth. As a result, the source document review and collaboration processes become more time consuming and less efficient as collaborators try to coordinate the short notes in the multiple document versions into a single working source document.

To address these issues, a system is proposed that detects when one or more short notes are created in a source document and creates a long note. A long note is a separate document created by the system that captures and compiles each short note and related source content from a source document for independent review and modification. Once created, the long note contains an entry for each short note, which entries are arranged in the long note based on a position of each short note in the source document. Each entry contains a short note, captured source content related to the short note, and a selectable option (which, if selected, connects to an anchor point for the short note in the source document). For example, in the instance of the word document with a short note, the long note may contain an entry with (1) a selectable option back to the source document (based on an anchor point of the short note in the source document), (2) a copy of the short note, and (3) related source content, such as the paragraph of the word document to which the short note is directed. The user may create or modify an entry and/or short note in the long note and the system will dynamically update the source document with the change.

To connect the long note, short note, source content, and source document together, durable anchor points are created at a position of the short note within the source document. An anchor point is a durable connection between the short note, corresponding source content in the source document, and the long note. The user may modify the short note and/or the source content directly in the long note and the modification will be dynamically updated in the source document. Similarly, if the user modifies the source content and/or the short note in the source document, it will be dynamically updated in the long note. Moreover, since the anchor point is durable, when the source content is moved to a different position within the source document, the anchor point between the short note and the corresponding source content is maintained. In instances where the source content or short note are deleted, the entry corresponding to the short note will be moved to a separate section of the long note for deleted entries. In this way, the short note and source content are not be lost throughout the review and revision process.

Source content is the related text, images, videos, audio files, and/or other information within the source document to which the short note is directed. Source content forms the setting for a short note so that it can be fully understood in the long note without reference back to the source document. For example, the source content may be a paragraph in a word document, an embedded video in a power point slide, a textual record from a lecture within a shared document, or any other piece of source content in a source document that a short note is directed toward. In these examples, the short note may be text providing a positive affirmation of the paragraph in the word document, a recommendation to make some edits to the video, or a question about the textual record. The system may utilize machine learning or natural language processing methods to identify and capture source content determined to be referenced by or related to the short note.

In some embodiments, a single long note may be created for a source document and each user of the source document may collaboratively utilize and store their created short notes in the single long note. This provides the benefit of easier collaboration because each user is able to view and modify the various short notes in a single long note. Additionally, it may provide the benefit of minimizing duplicative work where multiple people recognize the same issue in a source document or have similar edits. Rather than having each person spend time on the same issue the second or third user to see the issue may be able to leave a short note such as “I agree” or “My view as well” which can expedite the workflow process.

In other embodiments, each user of a source document may have a long note created specifically for their own short notes. In this case, if three users were working on a source document then three long notes would exist, one for each user. In this embodiment, each long note may be private to the user or with limited access to other users. Having one or more personal long notes allows multiple users to review the source document with only a few other people able to view their work. This provides the benefit of anonymity among coworkers which in turn may result in a supervisor receiving multiple solutions to the same issue that they otherwise would not.

The long note, regardless of how many are created, provides several benefits which address issues associated with source document review. First, the anchor points form a durable connection between the long note and source document. Second, the dynamic update process enables the long note to exist as a separate entity from the source document, yet both the long note and the source document can function as a fully up-to-date single source of truth. Third, the long note is self-arranging such that the entries and short notes within the entries are arranged based on their position in the source document, which means the long note is easy to digest without manual user organization. Fourth, the long note functions as a long-term record of the source documents history that can be referenced by one or more users over time to quickly Finally, the long note increases efficiency because it automatically captures and updates the short notes made in a source document so that a user can share their work with another collaborator without needing to take time to manually create a separate document with each short note.

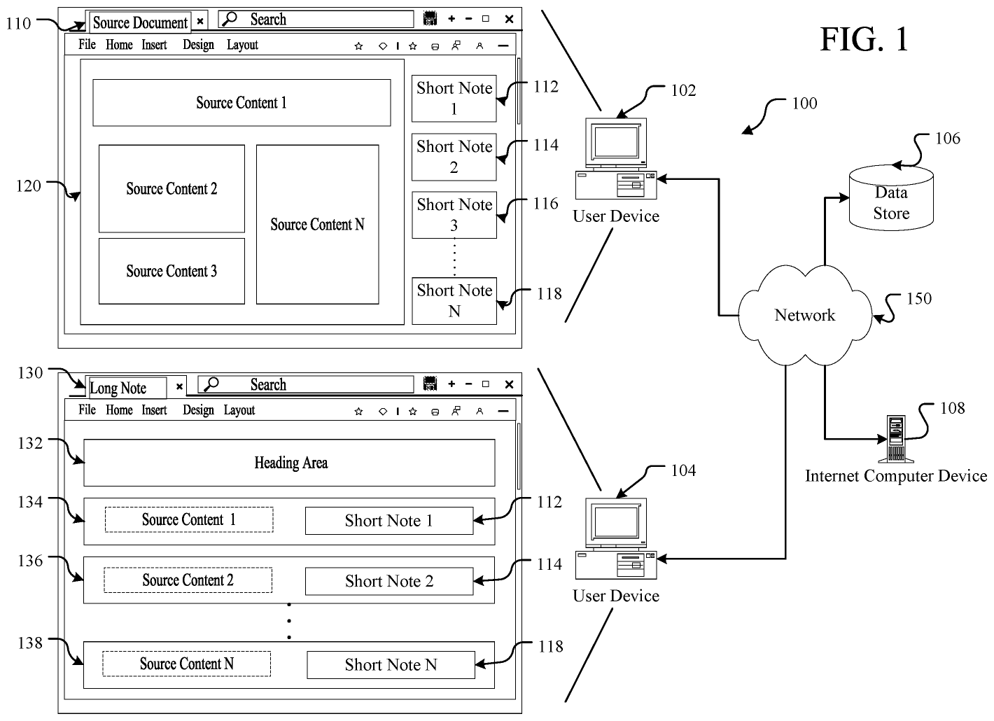

FIG. 1 illustrates an exemplary environment for dynamically composing and managing a long note from short notes, according to aspects described herein. As illustrated, environment 100 comprises a user device 102, user device 104, data store 106, internet computer device 108, network 150, source document 110, a plurality of short notes 112, 114, 116, and 118, source content area 120, long note 130, heading area 132, and a plurality of entries 132, 134, 136, and 138. The environment 100 may have a user device 102 and a user device 104 which communicate over network 150 with the data store 108. The network 150 may comprise one or more networks such as local area networks (LANs), wide area networks (WANs), enterprise networks, the Internet, etc. and may include one or more of wired, wireless, and/or optical portions.

User device 102 and user device 104 may be any device that can receive, process, modify, and communicate content on the network 150. Examples of a user device include a desktop computer, laptop computer, telephone, mobile device, tablet, and/or a wireless device. In accordance with some embodiments, the user devices 102 and 104 may have access to data contained in a data store 106. The data store 106 may contain information about the source content of a source document such as source document 110, short notes associated with the source document 110 such as the plurality of short notes 112, 114, 116, and 118, a long note such as long note 130, and information of the long note 130 such as heading area 132 as well as the plurality of entries 134, 136, and 138. In some instances, there may be a search functionality included with the source document 110 or long note 130. The use of search and suggestion functionality may involve a search of data store 106 over a network, such as network 150, or a separate, proprietary network. Accordingly, content from data store 106 may be presented in source document 110 and/or long note 130.

In a typical use scenario, a user may access a source document such as source document 110 on a user device 102. The source document 110 may be any digital representation of source content that may be displayed on user device 102 and/or user device 104 such as a word document, text document, slideshow presentation, video file, audio file, scanned or copied file, pdf, SharePoint, document review software, spreadsheet, drawing, image, image editing software, e-mail, coding window, etc. The exemplary source document 110 may have a source content area 120 which contains a plurality of source content such as source content 1, source content 2, and source content 3 to source content N. The source content within the source content area 120 may be a variety of information including text, audio files, video files, images, hyperlinks, code, etc. as well as the corresponding source document creation and editing tools supported by the source document 110.

In instances, the source document 110 may support a source document review function where short notes pertaining to the source content of the source document 110 can be created and displayed such as short notes 112, 114, 116, and 118. A short note includes brief content directly related to source content at a position within a source document. Often, the short note is comprised of text, but it may also include one or more of video files, audio files, images, hyperlinks, code, etc. singularly within the source document 110 and/or in combination with each other. In this instance, while using source document 110 the user creates short note 112 which is connected to source content 1.

In embodiments where a single long note is created for all users of the source document, if short note 112 is the first short note created for the source document 110, a long note 130 for every user of the source document is dynamically created on the user device 102 or on a separate internet computer device 108. The long note 130 will initially include the short note 112 created by the first user. Subsequent users to access the source document 110 and create or modify a short note, such as short note 118, will also see the short note 118 appear in the long note 130 as well as the short note 112 from the first user. In this embodiment, each user of the long note 130 and source document 110 will be able to see the short notes 112 and 118 that were created by another user. Additionally, they may be able to create their own short notes such as short note 114, as well as modify or respond to other user's short notes such as short notes 112 and 118.

In alternative embodiments where each user of a source document has a long note created specifically for their own short notes, if short note 112 is the first short note created for the source document 110 and for a first user, a first long note 130 is dynamically created for the short note 112 on the user device 102 or on a separate internet computer device 108. The first long note 130 is directly related to the first user and may be private such that only the first user and a limited number of additional users (e.g., supervisors, team members, other users who have been granted access) may access the first users short note 112 and first long note 130. At another point, if a second user reviews the source document 110, and creates a new short note 118, a second long note (not pictured) will be created in a substantially similar way for the second user. The second long note as well as the short note 118 in the source document 110 may not be visible to the first user or other users of the source document 110. Likewise, the first long note 130 and short note 112 may not be visible to the second user. Rather each source document may only be accessible by the user themselves and those with appropriate permissions.

In either embodiment, the creation, modification, use, and storage process of the one or more long notes, short notes 112, 114, 116, and 118, as well as the entries and anchor points function in a substantially similar way. Thus, in either embodiment, the long note 130 is a separate entity within a document management system that contains one or more entries, short notes, and associated source content for each anchor point within the source document 110. Once it is created, the long note 130 may be stored on a data store 106, the user device 102 that the source document 110 is created on, or an internet computer device 108.

In each embodiment, when creating the long note 130 the system 100 will determine an anchor point for the short note 112 that is connected to the source content of the short note 112. The system may utilize machine learning or natural language processing methods to identify the source content within the source document 110 determined to be referenced by or related to the short note 112. For example, if short note 112 is directed to source content 1 in source content area 120, then the anchor point will be tied to source content 1 based on the (including source content and a position) within the source document 110. The long note 130 may be comprised of a heading area 132 which describes the source document 110, and a plurality of entries 134, 136, and 138 as well as editing tools associated with the long note 130 file format. An entry is a design feature within the long note 130 for each anchor point within a source document 110. An entry may contain one or more short notes, source content in the source document related to the one or more short notes, and a selectable option (which when selected will open the source document 110 at the position of the short note. For example, entry 134 may contain a variety of information including the short note 112, a selectable option tied to the anchor point in the source document 110 that if selected will open the source document at short note 112, and/or optional source content such as source content 1. When the long note 130 is created it may be available to open on the user device 102 or another user device 104 based on the user selecting it. In alternative embodiments the long note 130 may open independently of user selection for display and selection on user device 102.

As the user continues to review the source document 110 and add one or more short notes such as short note 114, 116, and 118 to the source document 110, additional entries for the short notes, such as entries 136 and 138, will be automatically created in the long note 130. The entries are arranged in the long note 130 based on the anchor points' position in the source document 110. For example, as short note 112 is located before short note 118 in source document 110, entry 134 which contains short note 112 will be arranged before entry 138 which contains short note 118. When the source document 110 review and short note creation process is complete, the short notes created in the source document 110 should correspond to the number of short note entries in the long note 130.

In some instances, the same user or a different user with permission to access the source document 110, one or more short notes, and one or more long notes, such as a supervisor, may wish to review the short notes from the source document 110 without opening the source document 110 and searching through it. In such an instance, the user may open the long note 130 directly without opening the source document 110 to view and modify the short notes. For example, the supervisor may open the long note 130 on user device 104 for review. The supervisor, while reviewing the long note 130, may choose to modify one of the short notes such as short note 114. In this instance the supervisor has the option of editing the short note 114 directly in the long note 130, by selecting the selectable option in the entry 136, or by opening the source document 110 and editing the short note 114 in the source document 110. If the supervisor chooses to edit the short note 114 in the entry 136, the reviewer may edit it directly in the entry 136. Changes made by the supervisor or another user in the long note 130, will be dynamically updated in source document 110 the next time it is accessed by a user. Similarly, changes made in the source document 110 will be updated or added in the long note 130 as the source document 110 is being edited. In this way, multiple users may collaborate on the source document 110 simultaneously, without needing to spend additional time cataloguing changes to the source document 110 and updating them manually at a later time. The long note 130 acts as a single source of truth for the source document 110.

In some instances, the supervisor may be reviewing the long note 130 while another user is using the source document 110. If the user, creates a new short note such as short note 118 in the source document 110, the supervisor will see the new entry 138 dynamically created by the system 100 in the long note 130. The supervisor can then review the short note 118 and make any additional short notes which will be seen by the user in source document 110 as the system 100 dynamically updates the long note 130. When the reviewer has completed their review of long note 130 or the user has finished editing the source document 110, there is no need to communicate the exact short notes or changes among the team as both the source document 110 and long note 130 are dynamically updated to correspond with each other. Rather than a manual update of changes, the user can send an email or instant message alerting the other party that their actions are complete and the other party can open either for review. In some instances, the user may send an attachment corresponding to the source document 110 or long note 130 as well. As both the source document 110 and the long note 130 have the latest updates, either one may be utilized as reference at a later point without concern of loss of missing information.

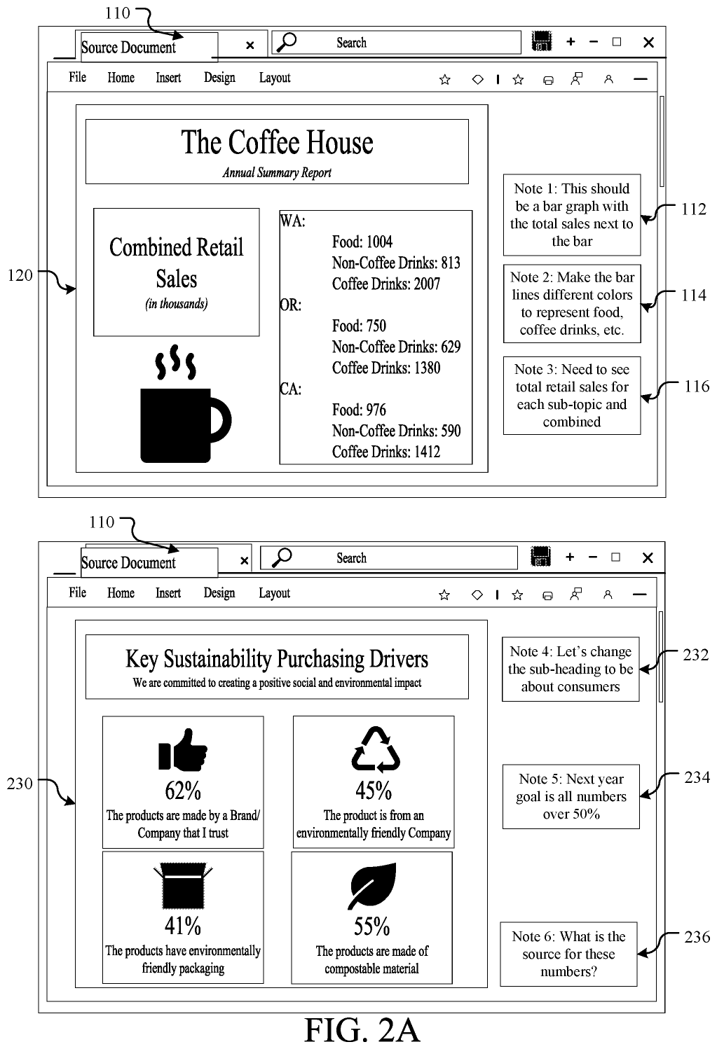

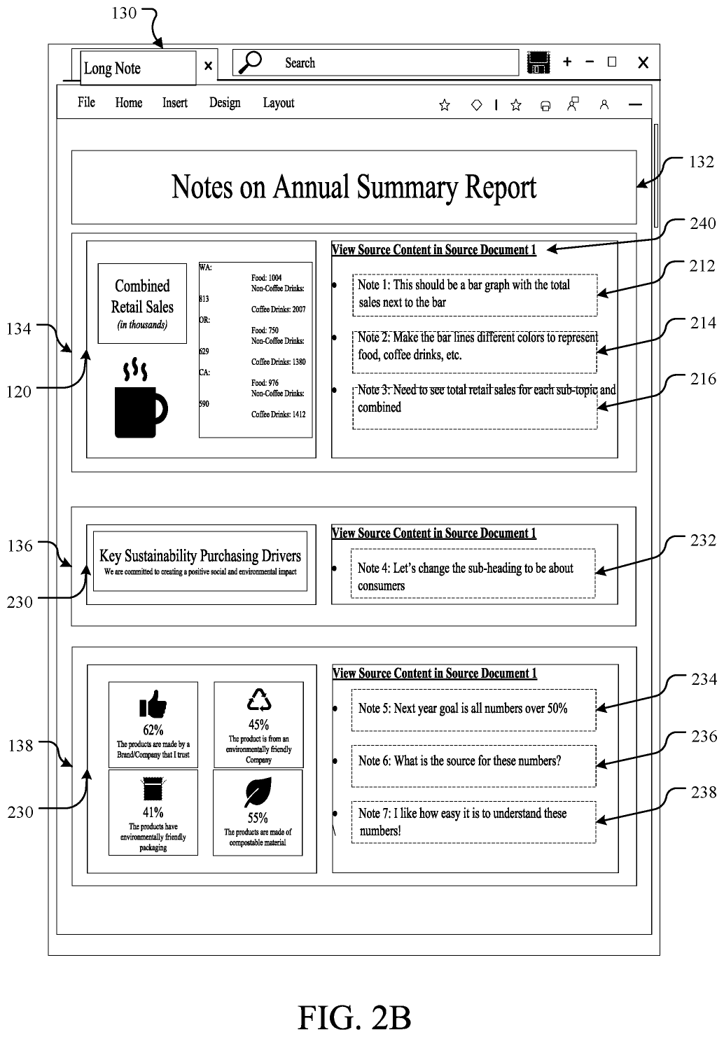

FIG. 2A illustrates an exemplary source document with short notes, according to aspects described herein. In instances, a user may access a source document 110. The source document 110 may be any digital representation of source content that may be displayed on user device 102 and/or user device 104 such as a word document, text document, slideshow presentation, video file, audio file, scanned or copied file, pdf, SharePoint, note-taking software, spreadsheet, drawing, image, image editing software, e-mail, coding window, etc. The source document 110 may contain a plurality of source content areas such as source content area 120, where the user may include a variety of information including text, audio files, video files, images, hyperlinks, code, etc., as well as the corresponding source content creation and editing tools supported by the source document 110. In the exemplary instance, the source content area 120 relates to the annual summary report of a business with combined retail sales in a slideshow. In instances, the user may create short notes, such as short notes 112, 114, and 116 that are connected to the source content in source content area 120. A short note may appear in the source document 110 located near the source content to which it relates. For example, short note 112 is located next to the source content area 120 as a text box.

When short note 112, is created the system determines an anchor point for the short note 112 that is connected to the source content of the source document 110. An anchor point is a durable relationship that connects the short note 112 to the source document 110. The anchor point may be comprised of multiple levels to allow for sub-nesting of multiple short notes or multiple anchor points with associated short notes. For example, short note 112 relates to the source content in source content area 120 that is presented as text for combined retail sales by state. The anchor point may be the slide itself or more specifically the specific section of the text such as the “Combined Retail Sales”. If a long note, such as long note 130, does not already exist for the source document 110, a new long note 130 will be created that uses the anchor point to tie the entry in the long note 130 to the source document 110.

In some instances, as the system creates an anchor point it will also capture source content related to the anchor point as well. The source content may be comprised of the source content related to the short note 112 including text, audio files, video files, images, hyperlinks, code, the section title, a passage of the selected text, a slide number, and/or a screenshot of the source content, etc. The source content may then be utilized by the system to present the connection to the short note 112 in the long note 130.

The durability of the anchor point as the connection between the short note 112 and corresponding source content continues even as the source document 110 is edited. The movement of a slide to a different position in the source document 110 does not disrupt the anchor point. Rather, the anchor point transitions to the new position while retaining the connection between the short note 112 and the corresponding source content. Similarly, if the source content that the anchor point is tied to is deleted from the source document 110, the short note 112 is not removed from the source document 110 or the long note 130. Rather, the long note 130 is rearranged to place the short note 112 in a section for source content that was removed. In this way, the continuity of the source document 110 is retained throughout the editing process. For example, if the user created a bar graph for source content area 120 as short note 112 suggests, the source content and anchor point for the short note 112 would be removed. In this instance, short note 112 would be moved to a section of the long note 130 for removed source content. In some instances, the source content associated with short note 112 may also be included in the long note 130 in the removed source content section.

As the user creates additional short notes, such as short notes 114 and 116, if the new short notes are connected to the same anchor point, then a new entry for the new short notes will be created in the long note 130 and tied to the pre-existing anchor point. For example, both short notes 114 and 116 are connected to the same source content as short note 112. Thus, the anchor point for short note 112 will be utilized to tie short notes 114 and 116 to the source document 110.

As the user progresses through the source document 110, they may view different source content areas such as source content area 230 and create additional short notes such as short notes 232, 234, and 236. As the user creates a new short note that is connected to a different piece of source content, a new anchor point is created as well to durably connect the short note to the different piece of source content. For example, source content area 230 contains information within the source document 110 related to sub-heading “Key Sustainability Purchasing Drivers.” The user may create a short note 232 related to this sub-heading and the system may create an associated anchor point and create a new entry in the long note 130.

In some instances, the user may create additional short notes, such as short notes 234 and 236, which exist in the same general position within the source document 110 but are not connected to each other. In this instance, the short notes may be viewed within the source document 110 in the same source content area 230 but be tied to different anchor points. For example, short notes 234 and 236 are related to the boxes contained within source content area 230, but not the sub-heading. In this instance, a different anchor point will be created for short notes 234 and 236 with a separate entry in the long note 130 than exists for short note 232. This will occur even though in the source document 110 short notes 232, 234, and 236 may each be displayed on the same slide.

FIG. 2B illustrates a long note created for the exemplary source document of FIG. 2A, according to aspects described herein. In instances, the user may choose to access the long note 130 directly to review and/or modify the short notes contained within the entries. Within the long note 130, the entries are arranged based on the position of the source content in the source document 110. For example, the entry 134 tied to the anchor point for source content area 120 appears in the long note 130 before the entries 136 and 138, which are tied to source content on a later slide. Similarly, entry 136 which relates to the sub-heading in source content area 230 appears before entry 138 which relates to the source content of the slide in source content area 230.

Within each entry, such as entry 134, is a selectable option 240, one or more short notes 212, 214, and 216, as well as source content related from the anchor point. If the selectable option 240 is selected by the user it may connect the user to the anchor point within the source document 110 for the entry 134. In the present instance, the selectable option 240 is displayed in bold font and underlined. However, persons having skill in the art will recognize that the selectable option may be displayed in a variety of ways. The short notes 212, 214, and 216 are displayed next to the source content from source content area 120 so that the user of the long note 130 may review the short note with the source content without needing to open the source document 110.

As previously discussed, each entry 134, 136, and 138 is related to separate anchor points within the source document 110. In some instances, as in entry 136, a single short note 232 with associated source content will be present in the entry 136. In other instances, such as entry 134, the multiple short notes 212, 214, and 216 will be displayed in the entry because each short note is connected to the same anchor point. Conversely, entry 136 and entry 138 are displayed separately because they have different anchor points despite having short notes and source content which would display on the same slide of source document 110. For this reason, the source content area 230 is referenced as source content for both entries 136 and 138.

In some instances, the user of the long note 130 may wish to modify or create a new short note within an entry and tied to the associated anchor point. In such an instance, the user may modify an existing short note and the modification will be dynamically updated in the short note when the source document 110 is next accessed. If the user creates a new short note within the long note 130, the short note will be attached to the relative anchor point in both the long note 130 and dynamically updated in the source document 110 when it is next accessed. For example, the user may wish to provide a positive short note 238 in entry 138. The new short note 238 will be created within the long note 130 and dynamically updated in the source document 110 on the same slide as source content area 230 tied to the same anchor point as short notes 234 and 236. If both the long note 130 and source document 110 are both open at the same time then any modification to either relating to entries, short notes, anchor points, and/or associated source content will be dynamically updated in both source document 110 and long note 130 and visible to the user of each. Although not pictured in FIG. 2B, an additional section may be created in the long note 130 to contain short notes, anchor points, entries, and/or associated source content that has been removed from the source document 110.

Although the arrangement of both the source document 110 and long note 130 have been provided as examples for discussion, one skilled in the art will understand that there are a plurality of visual displays which could be utilized to arrange and present this information to a user.

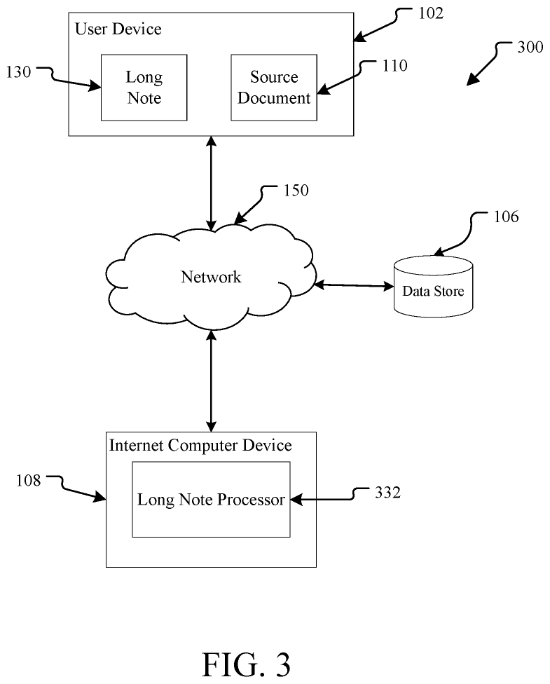

FIG. 3 is a diagram illustrating a system for dynamically composing and managing a long note from short notes, according to aspects described herein. As illustrated, system 300 comprises a user device 102, a data store 106, an internet computer device 108, long note processor 332, and a network 150. For ease of discussion, the description herein refers to a single user device 102, a single data store 106, and a single internet computer device 108. But features and examples of the user device 102, the data store 106, and the internet computer device 108 are applicable to multiple devices (e.g., user device 104 in FIG. 1). The network 150 may comprise one or more networks such as local area networks (LANs), wide area networks (WANs), enterprise networks, the Internet, etc. and may include one or more of wired, wireless, and/or optical portions.

User device 102 may be any type of computing device that can receive, process, modify, and communicate content on the network 150. Examples of a user device 102 include a mobile computer or mobile computing device (e.g., a Microsoft® Surface® device, a laptop computer, a notebook computer, a tablet computer such as an Apple iPad™, a netbook, etc.), or a stationary computing device such as a desktop computer or PC (personal computer). User device 102 may be configured to execute one or more software applications (or “applications”) and/or services and/or manage hardware resources (e.g., processors, memory, etc.), which may be utilized by users of the user device 102 and/or the internet computer device 108.

The user device 102 may include an application (not pictured) which displays content for use on the user device 102 and for communication across the network 150. The application may be a native application or a web-based application. The application may operate substantially locally to user device 102 or may operate according to a server/client paradigm in conjunction with one or more servers (not shown). The application may be used for content creation and modification such that source document 110 and long note 130 may be accessed and interacted with on the application. Source document 110, and long note 130 function in a substantially similar way to those aspects described in FIG. 1 and FIGS. 2A-2B, and for ease of discussion will not be redescribed here.

Data store 106 is a network server, cloud server, network attached storage (“NAS”) device, or another suitable computing device. Data store 106 may include one or more of any type of storage mechanism, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data store 106 is shown in FIG. 3, the system 300 may include two, three, or more similar instances of the data store 106. Moreover, the network 150 may provide access to other data stores, similar to data store 106 that are located outside of the system 300, in some embodiments. The source document 110 and long note 130 are stored in data store 106.

Internet computer device 108 may include one or more server devices, distributed computing platforms, cloud platform devices, processors, and/or other computing devices such as long note processor 332. Internet computer device 108 and long note processor 332 may communicate with data store 106 and user device 102 via network 150.

Long note processor 332 manages the long note 130 generation and modification process. The long note processor 332 analyzes the source document 110 to identify the creation of a new short note or modification of an existing short note. The long note processor 332 determines an anchor point that is durable and connected to the position of the short note within the source document 110. In some instances, the long note processor 332 captures source content related to the short note, that may be displayed in an entry in the long note 130 to provide the user of the long note 130 insight between the source document 110 and the short note as well as in some instances position information. The long note processor 332 may use machine learning or natural language processing methods to identify the connected source content and capture it. In some embodiments where a single long note will exist for all users of the source document the long note processor 332 creates the single long note 130 for source document 110 if no long note 130 is pre-existing. If a long note 130 is pre-existing and the source document 110 is accessed, the long note processor 332 will dynamically update the long note 130 with the additional short notes at the appropriate position within the long note 130.

In alternative embodiments where a long note is created for each user of the source document 110, the long note processor 332 creates a long note, such as long note 130, for each user of the source document 110. When a short note 112 is created, the long note processor 332 will determine if a long note exists for the source document 110 and the user particularly. If a long note does not exist for both the user and the source document 110 the long note processor 332 will create a new long note 130. If a long note 130 is pre-existing the long note processor 332 will dynamically update the long note 130 with the short note 112 at the appropriate position within the long note 130.

The long note processor 332 manages the modification and creation of short notes within the one or more long notes, such as long note 130. When a short note is created in the source document 110, the long note processor 332 creates an entry in the long note 130 that includes the short note, a selectable option that connects to the anchor point in the source document 110, and in some instances source content related to the short note. In some instances, an anchor point will have one or more short notes associated with it. In this case the long note processor 332 will include multiple short notes within the same entry along with the selectable option and the optional source content.

In some instances, a user may choose to modify an existing short note and/or entry and/or create a new short note and/or entry in either the long note 130 or the source document 110. In either instance, the long note processor 332 will process the modification or creation in both the long note 130 and source document 110 by dynamically updating the modification or creation. If the modification or creation is made when only the source document 110 is open then the long note processor 332 will dynamically update the long note in data store 106, and the update will be reflected when next accessed by the user. If the modification or creation is made when only the long note 130 is open then the long note processor 332 will dynamically update the relevant portion of the source document 110 when it is next accessed by the user. Additionally, if both the long note 130 and source document 110 are open and a user modifies or creates a short note and/or entry in either the long note 130 or source document 110, the long note processor 332 will dynamically update the other item in real-time.

In some instances, the source document 110 may be accessed by a user on a user device 102 while the long note 130 is accessed by a different user on a different user device (e.g., user device 104 from FIG. 1). In this case, if either user modifies and/or creates a short note and/or entry the long note processor 332 will dynamically update the other item in real-time and both users will be able to view the update as it occurs. If a new short note and/or entry is added within the long note 130 it will be attached to the connected anchor point in the source document 110. In embodiments where each user has their own long note 130, the long note processor 332 manages access rights to each long note 130 and the visibility of short notes such as short note 112 within the source document 110 to other users.

In one instance, when a source document 110 with a pre-existing long note 130 is re-accessed by the user, the dynamic update by the long note processor 332 may occur for all short notes existing throughout the source document 110 at once. Alternatively, the dynamic update may occur as needed based on the portion of the source document 110 the user is viewing, and the anchor points associated with that portion of the source document 110.

The long note processor 332 arranges the entries in the long note 130. The entries are arranged in the long note 130 by anchor point based on the anchor points' position in the source document 110. The style and visual depiction of the entries in the long note 130 may vary based on design choice. In some instances, the entries may be arranged as a bulleted list in the long note 130 with associated source content and selectable option, as in FIG. 2B. In other embodiments, the presence or absence of the amount and type of source content may vary to include a screenshot, title or heading from the source document 110, body content, images, and/or videos among other information. Persons having skill in the art will understand the nature and variety of arrangements for the long note 130 which are contemplated as well as how to accomplish the design.

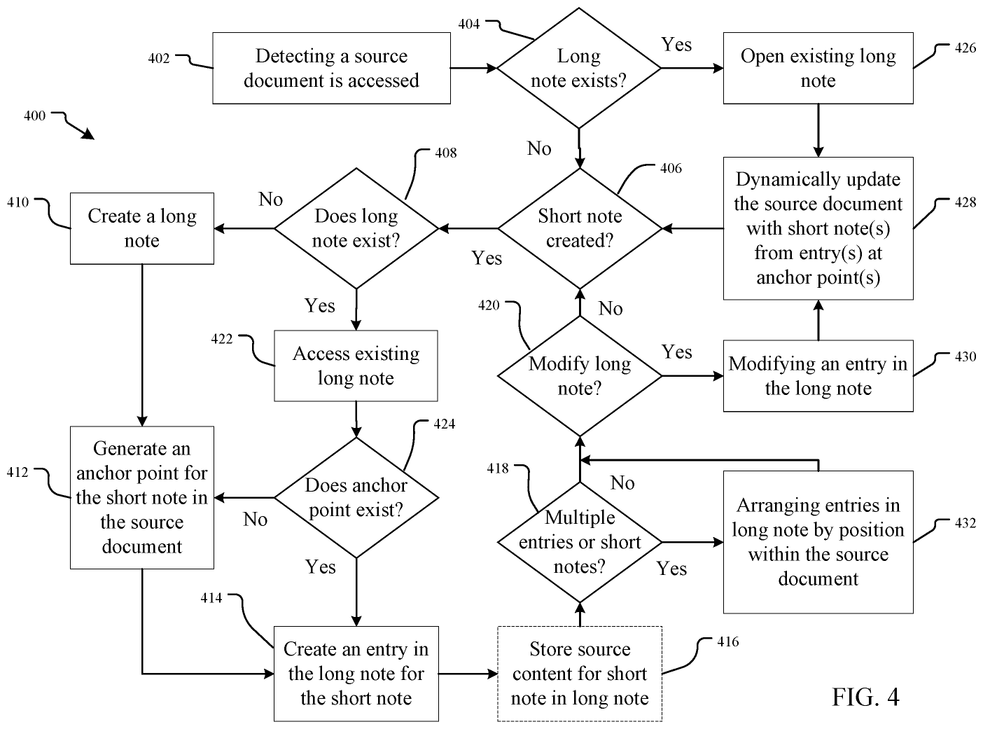

FIG. 4 is a block diagram illustrating a method for creating, managing, and dynamically updating a long note and a related source document, according to aspects described herein. A general order of the operations for the method 400 is shown in FIG. 4. Generally, the method 400 begins with operation 402 and ends when the source document is closed. The method 400 may include more or fewer steps or may arrange the order of the steps differently than those shown in FIG. 4. The method 400 can be executed as computer-executable instructions executed by a computer system and encoded or stored on a computer readable medium. Further, the method 400 can be performed by gates or circuits associated with a processor, an ASIC, an FPGA, a SOC or other hardware device. Hereinafter, the method 400 shall be explained with reference to the systems, components, devices, modules, software, data structures, data characteristic representations, signaling diagrams, methods, etc., described in conjunction with FIGS. 1, 2A, 2B, 3, 5, 6, 7, and 8.

Flow begins with detect operation 402, where the long note processor (e.g., long note processor 332) detects that a source document (e.g., source document 110) is being accessed. The source document may be accessed on a user device (e.g., user device 102 or 104) on an application for creation or modification.

Flow progresses to decision operation 404, where the long note processor (e.g., long note processor 332) determines if a long note (e.g., long note 130) exists for the source document (e.g., source document 110) that was accessed. In embodiments where a single long note exists for each user of the source document, this may be a global determination where the long note processor determines if the single long note has been created. Alternatively, in embodiments where each user of a source document has a long note created specifically for their own short notes, the long note processor may determine if the long note exists specifically for the user or not. If a long note does exist, either generally for the source document or specifically for the user, flow progresses to open operation 426, where the long note processor (e.g., long note processor 332) opens the existing long note. The existing long note may be stored in a data store (e.g., data store 106) and contain the entries with one or more short notes from the source document.

Flow then progresses to update operation 428, where the long note processor (e.g., long note processor 332) dynamically updates the source document (e.g., source document 110) with the one or more short notes from the entries in the long note (e.g., long note 130) at the appropriate anchor point. In some instances, the source document will be dynamically updated with all short notes from the long note. Alternatively, only the portion of the source document that the user is accessing will be dynamically updated with one or more short notes by the long note processor. In this instance, the other short notes will be dynamically updated as the user accesses a different portion of the source document.

Alternatively, from operation 404, if no long note exists either generally for the source document (e.g., source document 110) or specifically for the user of the source document, then flow progresses to decision operation 406, which determines if a short note is created. When the source document is accessed, the long note processor (e.g., long note processor 332) analyzes the source document to determine if a short note has been created. If no short note is created, then flow ends when the source document is closed. If a short note is created, then flow progresses to decision operation 408, which determines if a long note (e.g., long note 130) exists for the source document.

If a long note does not exist for the source document (e.g., source document 110) at operation 408, then flow progresses to operation 410 where the long note processor (e.g., long note processor 332) creates a long note (e.g., long note 130) for the source document. When initially created, the long note includes at least the first short note arranged according to its position within the source document. Flow progresses to generate operation 412, where an anchor point is generated by the long note processor for the short note in the source document. The anchor point is a durable position which ties the short note and source content in the source document to the long note.

If a long note does exist for the source document (e.g., source document 110) at operation 408, then flow progresses to access operation 422 where the long note processor (e.g., long note processor 332) accesses the long note (e.g., long note 130) in the data store (e.g., data store 106). The long note does not need to be opened for the method to flow, although it may be open simultaneously with the source document and the method may still flow properly. When the long note is accessed, flow progresses to decision operation 424, which determines if an anchor point exists. If an anchor point does not exist, flow progresses to generate operation 412, where an anchor point is generated by the long note processor for the short note in the source document.

If an anchor point does exist at operation 424 or following operation 412, flow progresses to create operation 414 where an entry is created in the long note (e.g., long note 130) for the short note at the anchor point by the long note processor (e.g., long note processor 332). The entry includes the short note and a selectable option which connects to the short note at the anchor point in the source document (e.g., source document 110) if selected. A new entry is created for each anchor point that exists in the source document. If multiple anchor points are generated over multiple iterations at operation 412, then multiple entries will be generated for each anchor point over each iteration of the flow.

Flow progresses to store operation 416, where optional source content is stored for the short note in the long note (e.g., long note 130). In some embodiments, the entry may also include source content related to the short note. The source content may be captured by the long note processor (e.g., long note processor 332) and stored in the entry to provide additional information when viewing the short note in the long note.

Flow progresses to decision operation 418, which determines if multiple entries exist in the long note (e.g., long note 130). If there is only one short note in the source document (e.g., source document 110), then only one entry will exist in the source document and flow will progress to modify operation 420.

If multiple entries or short notes exist in the source document (e.g., source document 110), then flow progresses to arrange operation 432. If multiple short notes exist in the source document but they are all tied to the same anchor point in the source document, then the long note processor (e.g., long note processor 332) will arrange the short notes within the entry based on their position in the source document. If multiple short notes exist in the source document but they are tied to more than one anchor point, then multiple entries exist in the long note (e.g., long note 130) and the long note processor will arrange the entries in the long note based on the position of the anchor points in the source document. The long note processor will also arrange the short notes within each entry based on their position in the source document.

Following operations 418 and 432, flow progresses to decision operation 420, which determines if the long note (e.g., long note 130) has been modified. In instances where the long note is not being accessed concurrently with the source document (e.g., source document 110), then the long note is not being modified and flow will progress to operation 406. However, there may be instances where both the long note and the source document are being accessed concurrently and the long note is modified in some way. In these instances, flow progresses to modify operation 430 where one or more entries and/or the short notes in the entry are modified in the long note. In this instance, the long note processor (e.g., long note processor 332) recognizes the modification and flow progresses to update operation 428. At update operation 428, the long note processor dynamically updates the source document with the modifications from the short notes and/or the entries in real-time. In this instance, the modifications will be visible in both the long note and the source document as the long note processor is making the dynamic update.

Flow then progresses to decision operation 406, where the long note processor (e.g., long note processor 332) continues to analyze the source document (e.g., source document 110) to determine if another short note is created. If another short note is created then the flow will proceed to operation 408 and so on through another iteration of the method. If another short note is not created, then the method ends when the source document is closed.

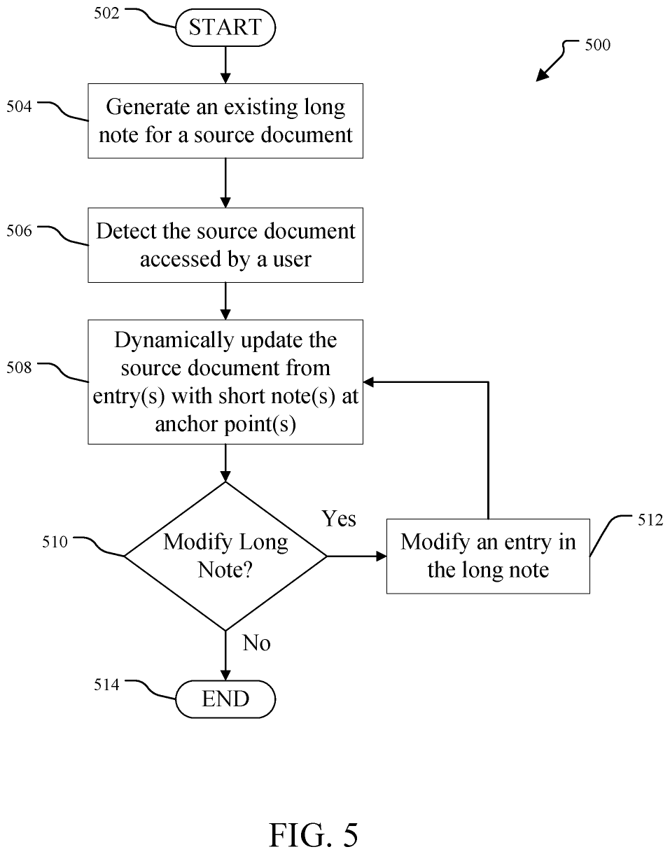

FIG. 5 is a block diagram illustrating a method for dynamically managing a long note and dynamically updating a source document from the long note, according to aspects described herein. A general order of the operations for the method 500 is shown in FIG. 5. Generally, the method 500 begins with start operation 502 and ends with end operation 514. The method 500 may include more or fewer steps or may arrange the order of the steps differently than those shown in FIG. 5. The method 500 can be executed as computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2A, 2B, 3, 4, 6, 7, and 8.

Following the start operation 502, flow progresses to generate operation 504, where an existing long note (e.g., long note 130) is generated by a long note processor (e.g., long note processor 332). The long note is related to a source document (e.g., source document 110) and may be accessed independently of the long note so that the entries and associated short notes may be viewed, modified, and/or created.

Flow progresses to detect operation 506, where the long note processor (e.g., long note processor 332) detects that the source document (e.g., source document 110) is accessed by the user. The long note (e.g., long note 130) and the source document may be accessed simultaneously by the same user or in some instances by multiple users based on system capabilities.

Flow progresses to update operation 508, where the long note processor (e.g., long note processor 332) dynamically updates the source document (e.g., source document 110) with the one or more short notes from the entries in the long note (e.g., long note 130) at the appropriate anchor point. In some instances, the source document will be dynamically updated with all short notes from the long note. Alternatively, only the portion of the source document that the user is accessing will be dynamically updated with one or more short notes by the long note processor. In this instance, the other short notes will be dynamically updated as the user accesses a different portion of the source document.

Flow progresses to decision operation 510, which determines if the long note (e.g., long note 130) has been modified. The entries and/or short notes in the long note may be modified by the user, and if this occurs flow progresses to modify operation 512 where an entry and/or associated short note are modified. Modification may involve adding and/or deleting source content in an existing entry or short note, moving the entry or short note to a different position, and/or creating a new entry or short note related to an existing anchor point and/or new anchor point. When the long note processor (e.g., long note processor 332) detects modification of the long note, flow progresses to update operation 508, where the long note processor dynamically updates the source document (e.g., source document 110) with the modification at the anchor point. As operation 508 functions substantially similarly to the description above it will not be redescribed here. The loop between operations 508, 510, and 512, continues until there are no more modifications to the long note, at which point the method ends at end operation 514.

As will be appreciated, the various methods, devices, apps, nodes, features, etc., described with respect to any of the figures described herein, are not intended to limit the system to being performed by the particular apps and features described. Accordingly, additional configurations may be used to practice the methods and systems herein and/or features and apps described may be excluded without departing from the methods and systems disclosed herein.

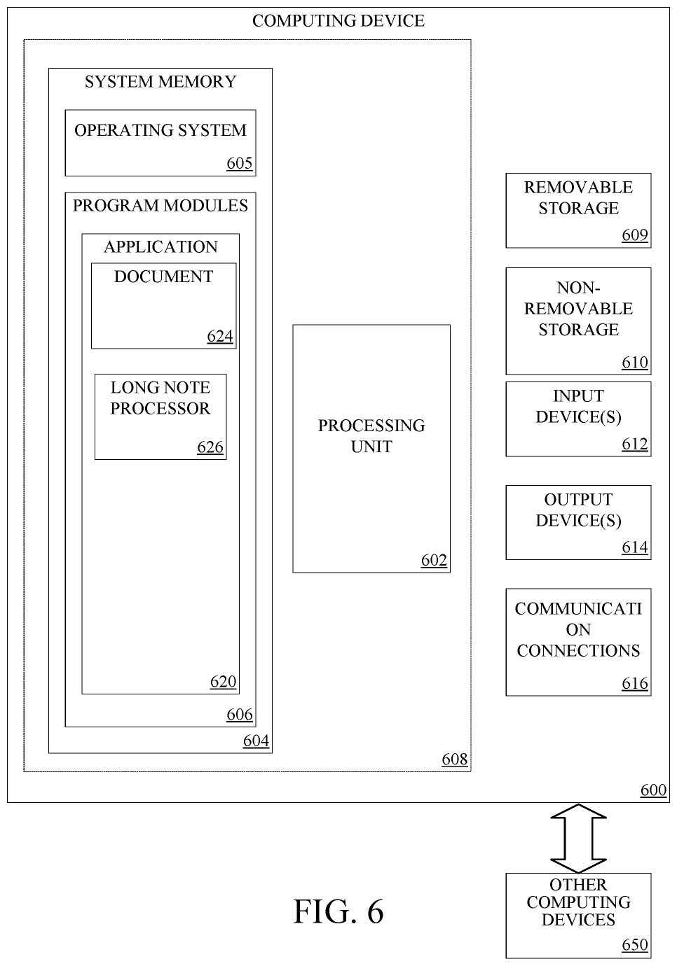

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including user device 102, as well as one or more devices associated with enterprise devices 106 and 108. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store source document 624 and long note processor 626. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

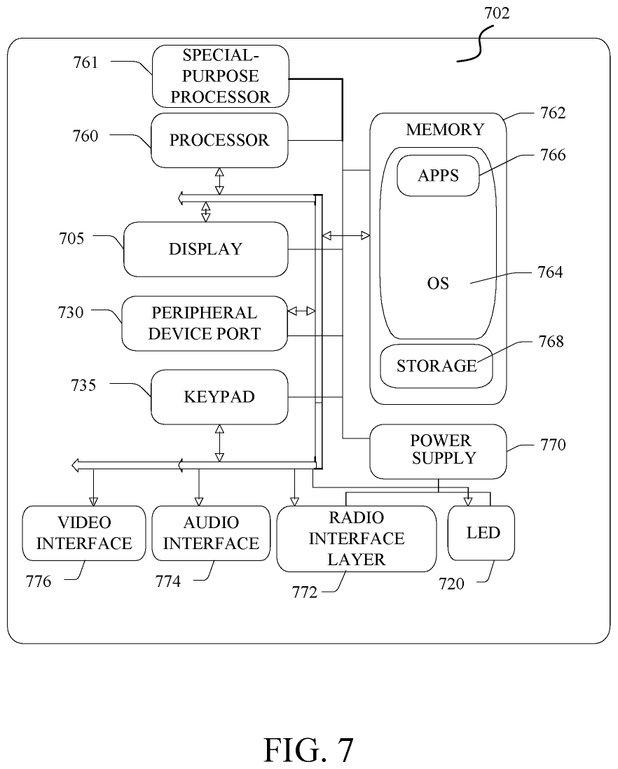

FIG. 7 is a block diagram illustrating the architecture of one aspect of a computing device 700 (not shown) for example, a mobile telephone, a smart phone, wearable computer (such as a smart watch), a tablet computer, a laptop computer, and the like, with which embodiments of the disclosure may be practiced. In some aspects, the client may be a mobile computing device. That is, the computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 1068 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the computing device 700 and stored via the system 702 may be stored locally on the computing device 700, as described above, or the data may be stored on any number of storage media that may be accessed by the device via the radio interface layer 772 or via a wired connection between the mobile computing device 700 and a separate computing device associated with the computing device 700, for example, a server computer in a distributed computing network, such as the Internet. As should be appreciated such data/information may be accessed via the computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

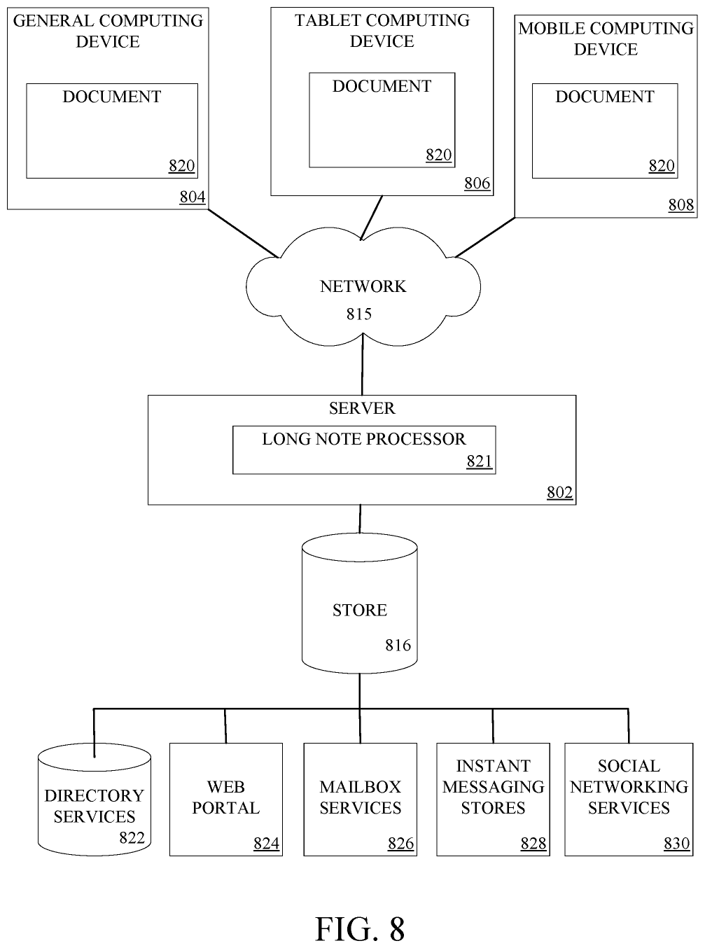

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various source documents may be stored using a directory service 822, a web portal 824, a mailbox service 826, an instant messaging store 828, or a social networking site 830.

A source document 820 may be employed by a client that communicates with server device 802, and/or long note processor 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts described in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
at least one processor; and
memory storing instructions that, when executed by the at least one processor, causes the system to perform a set of operations, the set of operations comprising:
detecting a source document being accessed by a user;
receiving a first note associated with a first source content having a first position in the source document;
creating a separate document for the source document that is separate from the source document and the first note;
generating a first anchor point for the first note based on the first position in the source document;
creating a first entry in the separate document including the first note and source content related to the first note, wherein the first entry in the separate document is arranged according to the first position of the first anchor point in the source document;
receiving a modification to the source content in the first entry of the separate document without modifying the first note; and
dynamically updating the source document at the first anchor point with the modified source content from the first entry.

2. The system of claim 1, further comprising:
storing the source content for the first short note in the separate document.

3. The system of claim 1, further comprising:
creating a second note associated with the first source content having the first position in the source document at the first anchor point;
accessing the separate document for the source document; and
creating a second entry in the separate document for dynamically updating the second note at the first anchor point in the source document.

4. The system of claim 3, further comprising:
storing source content for the second short note in the separate document.

5. The system of claim 1, further comprising:
creating a second note associated with a second source content having a second position in the source document;
accessing the separate document for the source document;
generating a second anchor point for the second note based on the second position in the document;
creating a second entry in the separate document for dynamically updating the source document with the second note at the second anchor point; and
arranging the first entry and the second entry in the separate document by position within the source document.

6. The system of claim 5, further comprising:
storing source content for the second note in the separate document.

7. The system of claim 1, further comprising:
receiving a modification to the first entry in the separate document; and
dynamically updating the first note in the source document with the modified first entry.

8. A method comprising:
detecting a source document being accessed by a user;
receiving a first note associated with first source content having a first position in the source document;
creating a separate document capturing a connection between the first note and long note for the source document;
generating a first anchor point for the first note based on the first position in the source document;
creating a first entry in the long note separate document including the first note and source content related to the first note, wherein the first entry in the separate document is arranged according to the position of the anchor point in the source document;
receiving a modification to the source content in the first entry of the separate document without modifying the first note; and
dynamically updating the source document at the first anchor point with the modified source content from the first entry.

9. The method of claim 8, further comprising:
storing source content for the first note in the separate document.

10. The method of claim 8, further comprising:
creating a second note associated with the first source content having the first position in the source document at the first anchor point;
accessing the separate document for the source document; and
creating a second entry in the separate document for dynamically updating the second note at the first anchor point in the source document.

11. The method of claim 10, further comprising:
storing source content for the second note in the separate document.

12. The method of claim 8, further comprising:
creating a second note associated with second source content having a second position in the source document;
accessing the separate document for the source document;
generating a second anchor point for the second note based on the second position in the source document;
creating a second entry in the separate document for dynamically updating the source document with the second note at the second anchor point; and
arranging the first entry and the second entry in the separate document by position within the source document.

13. The method of claim 12, further comprising:
storing source content for the second note in the separate document.

14. The method of claim 8, further comprising:
receiving a modification to the first entry in the separate document; and
dynamically updating the first note in the source document with the modified first entry.

15. The method of claim 8, wherein a note further comprises content directed toward or about source content in the source document.

16. The method of claim 8, wherein an anchor point further comprises a connection between the source content of the source document, a related note, and the separate document.

17. A method comprising:
accessing an existing separate document for a source document, wherein the separate document includes at least a first entry including a first note and the separate document captures a connection between the first note and the source document;
detecting the source document being accessed by a user;
receiving a modification to a source content of the first entry of the separate document without modifying the first note; and
dynamically updating the source document with the modified source content from the first entry.

18. The method of claim 17, further comprising:
receiving a modification to the content of the first note of the first entry in the existing separate document; and
dynamically updating the source document with the modified content of the first note from the first entry in the separate document.

19. The method of claim 17, wherein an entry further comprises a design feature within the separate document for each anchor point within a source document wherein the design feature contains one or more notes, source content related to the one or more notes, and a selectable option which when selected will connect to the note in the source document.

20. The method of claim 17, wherein a separate document further captures each of the one or more notes and related source content from the source document and compiles them in one place for independent review and modification.
